(19) United States
(12) Patent Application Publication
(10) Pub. No.: US 2026/0252481 A1
(43) Pub. Date: Aug. 27, 2026

(54) PREDICTION STORAGE EFFICIENCY

(71) Applicant: Arm Limited, Cambridge (GB)

(72) Inventors: Alexander Cole SHULYAK, Austin, TX (US); Robert Douglas CLANCY, Apex, NC (US); Michael Bryan MITCHELL, Fuquay-Varina, NC (US); ABHISHEK RAJA, Niagara Falls, NY (US); Rami Mohammed AL SHEIKH, Morrisville, NC (US)

(21) Appl. No.: 19/064,926

(22) Filed: Feb. 27, 2025

(51) Int. Cl. G06F 12/02

(52) U.S. Cl. CPC G06F 12/023; G06F 9/3832; G06F 9/3838; G06F 9/3842; G06F 2212/251

(57) ABSTRACT

There is provided a data processing apparatus in which prediction circuitry stores a plurality of mappings from instructions to payloads. Query circuitry responds to a reference to one of the instructions provided as at least part of an input by outputting one of the payloads that maps to the one of the instructions. The payloads include one of a plurality of predictions and a prediction type that indicates which of a plurality of data speculation techniques the one of a plurality of predictions relates. The prediction circuitry stores, for each of the instructions, the prediction type as one of a plurality of different prediction types.

### TECHNICAL FIELD

The present disclosure relates to data processing and particularly predictions for instruction execution.

### DESCRIPTION

A data processing apparatus may offer a number of techniques for predicting data values (e.g. for load instructions) so that other instructions can continue to execute while that data is obtained from memory. In practice, however, it may be the case that only one of these techniques can be used per instruction instance. This can therefore lead to storage wastage, since entries for multiple instructions might otherwise be stored. In addition, determining which technique should be applied could be time consuming and therefore wasteful of processor throughput.

### SUMMARY

Viewed from a first example configuration, there is provided a data processing apparatus comprising: prediction circuitry configured to store a plurality of mappings from instructions to payloads; and query circuitry configured to respond to a reference to one of the instructions provided as at least part of an input by outputting one of the payloads that maps to the one of the instructions, wherein the payloads comprise one of a plurality of predictions and a prediction type configured to indicate which of a plurality of data speculation techniques the one of a plurality of predictions relates; and the prediction circuitry is configured, for each of the instructions, to store the prediction type as one of a plurality of different prediction types.

Viewed from a second example configuration, there is provided a data processing method comprising: storing a plurality of mappings from instructions to payloads; and responding to a reference to one of the instructions provided as at least part of an input by outputting one of the payloads that maps to the one of the instructions, wherein the payloads comprise one of a plurality of predictions and a prediction type configured to indicate which of a plurality of data speculation prediction techniques the one of a plurality of predictions prediction type relates; and for each of the instructions, the prediction type is stored as one of a plurality of different prediction types.

Viewed from a third example configuration, there is provided a system comprising: the data processing apparatus, implemented in at least one packaged chip; at least one system component; and a board, wherein the at least one packaged chip and the at least one system component are assembled on the board.

Viewed from a fourth example configuration, there is provided a chip-containing product comprising the system, wherein the system is assembled on a further board with at least one other product component.

Viewed from a fifth example configuration, there is provided a non-transitory computer-readable medium storing computer-readable code for fabrication of the data processing apparatus.

### BRIEF DESCRIPTION OF THE DRAWINGS

The present invention will be described further, by way of example only, with reference to embodiments thereof as illustrated in the accompanying drawings, in which:

FIG. 1 schematically illustrates a data processing apparatus in accordance with some examples;

FIG. 2A gives a simple overview of memory renaming;

FIG. 2B gives a simple overview of data value prediction;

FIG. 3 shows two variant techniques that can be shown regarding the implementation of data value prediction;

FIG. 4 shows the query circuitry and the prediction circuitry in the context of training and determination as to the data value speculation technique to be used;

FIG. 5 illustrates an example of a process of determining which of several data value speculation techniques should be applied to a particular instruction, in the form of a flowchart;

FIG. 6 illustrates an example similar to that of FIG. 1;

FIG. 7 illustrates a flowchart that shows how allocation filtering might take place;

FIGS. 8A-8E illustrates an example of training;

FIG. 9 shows one or more packaged chips, with the apparatus implemented on one chip or distributed over two or more of the chips; and

FIG. 10 illustrates a flowchart that shows a method of data processing in accordance with some examples.

### DESCRIPTION OF EXAMPLE EMBODIMENTS

Before discussing the embodiments with reference to the accompanying figures, the following description of embodiments is provided.

In accordance with one example configuration there is provided a data processing apparatus comprising: prediction circuitry configured to store a plurality of mappings from instructions to payloads; and query circuitry configured to respond to a reference to one of the instructions provided as at least part of an input by outputting one of the payloads that maps to the one of the instructions, wherein the payloads comprise one of a plurality of predictions and a prediction type configured to indicate which of a plurality of data speculation prediction techniques the one of a plurality of predictions prediction type relates; and the prediction query circuitry is configured, for each of the instructions, to store the prediction type as one of a plurality of different prediction types.

The query circuitry receives an indication of an instruction. This could be a reference to an instruction such as a program counter value (or part of a program counter value, such as the least significant bits) where the instruction is located. In some examples, the indication of instruction could differentiate between instances of the instruction by incorporating a call history (e.g. from a global history register), or a loop counter, etc. Regardless, the indication of the instruction is used to query the prediction circuitry that stores mappings from instructions to payloads. Given the instruction indication, it is possible to determine which instruction the reference is being made to and thereby return a stored payload (assuming there is a hit in the prediction circuitry). Either the stored payload is returned or an indication of a miss is returned. The payload includes a prediction type and a prediction. The prediction type indicates which of several data speculation techniques is applicable to the prediction. A data speculation technique is a type of prediction made in respect of data, which allows the data to be predicted in some manner before it can be obtained from memory. This makes it possible for later instructions to continue executing while the data is being fetched (which can be a slow process). If the prediction is correct then time is saved. Otherwise, the process can be rewound to the point where the prediction was made available, this time using the data that was actually fetched. The same instruction could therefore be subject to different data speculation techniques-although only one may be applied to any one instance of any instruction. Consequently, the same prediction circuitry can be used to provide predictions of both types with the different predictions being differentiated by indicating in the payload the type of prediction. This results in not only a smaller circuit area being provided as compared to a situation where two separate predictors are provided (since only one entry needs to be stored for each instruction) but also saves time as compares to a situation where it must be decided, each time, which of several available techniques should be applied.

In some examples, each of the instructions is a memory access instructions. For instance, they could be memory load instructions that load data from memory and into a register.

In some examples, the data speculation prediction techniques include a memory rename operation and a data value prediction operation. For some types of instructions (e.g. of a given opcode), it is possible that the instruction of that opcode may be eligible for data value prediction and another instruction of the same opcode may be eligible for memory renaming. Both types of prediction can happen at a similar time in the pipeline, and since it is generally unnecessary to provide a data value prediction where it is predicted that a memory rename operation is provided, the same prediction circuitry can be provided to indicate both types of prediction. This leads to a saving in terms of both power consumption and circuit size.

In some examples, in the memory rename operation, the one of the instructions is predicted as a load instruction that loads data from a memory address and the data is predicted to be produced by a corresponding producer instruction, which is a store instruction configured to store the data to the memory address prior to the instruction being executed. Memory renaming is a technique to accelerate the effective execution of a load in certain read-after-write scenarios. The load instruction can therefore refer to a memory address to which the store instruction writes. In other words, in the normal execution of instructions, the store instruction would write data from a register out to a particular address of memory and sometime later the load instruction would read data from that address of memory into a register. Consequently, with memory renaming, a consuming instruction that would have consumed data from the load instruction instead directly consumes data from the register that was used by the store instruction as the data to be stored. Meanwhile, the load instruction becomes a confirmation load, which loads the data from memory to ensure that the data did not change since it was stored to memory by the store instruction. Prediction involves predicting some indication of the store instruction that the load instruction should forward from. This could be a hash of the store instruction program counter value, a delta to the forwarding store, or some other arbitrary identifier. Separate logic in a rename stage tracks the general register file entry consumed by the store instruction so that the predicting load instruction can use it as its destination.

In some examples, the plurality of predictions includes: an indication of data that is predicted to be used by a value predictable instruction, and an indication of a previous producer instruction whose data is to be used by a memory renamable instruction. The format and meaning of the prediction is indicated by the prediction type, which indicates which of the data speculation techniques is applicable. For example, if the prediction type refers to memory renaming then the prediction data could be a reference to an instruction (or to a register) that produces the data used by the consumer instruction. The indication of an instruction could be achieved using a program counter value or a program counter offset, for instance. If the prediction type refers to data value prediction/speculation then the prediction may take the form of an indication of data that is to be used.

In some examples, the indication of the data is any one of: an indication of an index of data storage circuitry where the data can be found, and the data. The indication of the data could be the data itself or it could be a reference to a location in storage circuitry where the data can be found-for example, an index or a hash (which can be converted to an index). Whether or not the data or a data location is stored may depend on how many bits of storage is available for storage of the prediction data in the prediction circuitry as compared to the width of the data itself. The storage circuitry can take a number of forms, but in some examples it takes the form of a data value cache. In some examples, the prediction type is configured to differentiate between when payload data is the indication of the index of the data storage circuitry and when the payload data is the data. The prediction type can indicate whether the payload data is the data itself or an indication of where the data is located.

In some examples, the plurality of different prediction types includes non-prediction, which indicates that no data speculation prediction technique is used. In some situations, it may be desirable to note that a particular instruction (which could be subject to data value prediction or to memory renaming) should not be subject to any prediction mechanism. One situation in which may be desirable for the prediction circuitry to return a ‘no prediction’ result is where it has been established that the prediction that would be performed is incorrect. This is particularly true where the prediction cannot easily be corrected. One example of this, for instance, is an instruction whose behaviour is dependent on a random element. For instance, if the data loaded by an instruction is dependent on a random number then no amount of training may be able to accurately produce a good prediction. In this situation, the instruction can be marked as ‘no prediction’ to avoid expending resources on training or trying to obtain the prediction, which will inevitably be incorrect.

In some examples, the data processing apparatus comprises: determination circuitry configured to perform a determination of which of the data speculation techniques an instruction should be subject to; and training circuitry configured to update or allocate an entry in the prediction circuitry in respect of the instruction, based on the determination. The training circuitry can be responsible for adjusting a confidence associated with the prediction (e.g. increasing it when it is correct, and decreasing it when it is incorrect). Entries with a low confidence may be removed (or marked as ‘no prediction’ or the predictions may be replaced) and predictions that use a particular data speculation technique may not be output until the confidence value reaches a predetermined barrier. The determination circuitry works alongside the training circuitry and determines which technique should be used for an instruction. This can be selected from those techniques that the training circuitry indicates are valid—i.e. for which it is at least suspected that the technique may be usable.

In some examples, the data processing apparatus comprises: determination circuitry configured to perform a determination of whether an instruction should be subject to the memory rename operation and whether the instruction should be subject to the data value prediction operation; and training circuitry configured to update or allocate an entry in the prediction circuitry in respect of the instruction, based on the determination. The determination circuitry may, for instance, select between the memory rename operation or the data value prediction operation for a particular instruction.

In some examples, the training circuitry is configured to allocate an entry to the prediction circuitry based on an allocation condition, which differs for the plurality of data speculation techniques. For example, there may be no restrictions placed on allocation for memory renaming, whereas for data value prediction the restrictions may include repeatability or criticality of the instruction for allocation to occur.

In some examples, when the determination is that the instruction is subject to the memory rename operation, then the determination circuitry is configured to update the prediction circuitry with an indication that the instruction is subject to the memory rename operation irrespective of whether the determination is that the instruction is also subject to the data value prediction operation. Most load instructions, for instance, may be subject to data value prediction whereas a small number of load instruction might (also or alternatively) be subject to memory renaming. However, if memory renaming is applicable then there is a reasonable likelihood that the data value being used regularly changes. In this situation, trying to use data value prediction techniques may be likely to be problematic whereas memory renaming techniques may be more likely to succeed. Consequently, if the existence of memory renaming can be detected then it is preferable to treat the instruction as being subject to memory renaming even if it also happens to be (potentially) eligible for data value prediction. In contrast, if an instruction is not subject to the memory rename operation and is subject to the data value prediction operation then the prediction circuitry can be updated with an indication that the instruction is subject to the data value prediction operation.

In some examples, the determination circuitry is configured to determine which of the data speculation techniques an instruction should be subject to based on a hierarchy; and at least one of the data speculation techniques is determined based on a further condition being met. A hierarchy of preferences may be provided to control which of the different data speculation techniques the prediction circuitry is updated with (e.g. is used and/or training attempted). Certain techniques may be preferred over others or may be selected in preference to others—for example, memory renaming may be selected in preference to data value prediction. Separately to this, the prediction circuitry may only be updated in respect of a particular technique if a particular condition (or even multiple conditions) is/are met. These conditions might relate to training for instance, so that the prediction circuitry can still be updated in respect of a particular data speculation technique/prediction if training is being performed. Other conditions might relate to the confidence associated with a technique, or if the prediction made for a particular instruction will help to alleviate timing criticality.

In some examples, the training circuitry is configured to filter accesses to the prediction circuitry made in respect of a given instruction based on an indication of whether the given instruction is being trained or is trained. A trained indication can be provided in order to indicate whether training is taking place in respect of the current prediction/technique and instruction. Such an indication could be acquired at a time that the prediction circuitry is looked up for prediction and passed through the pipeline to an execution/training stage. In this way it is not necessary for the determination circuitry to perform a further lookup of the instruction to determine the training state.

In some examples, the training circuitry is configured to perform training in respect of the instruction using a predicted value comprising a determined payload comprising a determined prediction type and a determined prediction. This makes it possible for an arbitrary prediction algorithm to be used by replacing predicted values with payloads that include both a payload type and a predicted value.

In some examples, the prediction circuitry is configured to implement a replacement policy, which biases replacing mappings based on the prediction type. The prediction circuitry has a finite amount of storage. Where the number of instructions for which predictions may be made exceeds the capacity of the prediction circuitry, it is necessary for some entries to be deleted in order to make way for new entries. This process is known as replacement. The policy by which it is decided which entries are deleted to make way for new entries is known as the replacement policy. Typically, replacement policies look to delete the oldest entries, least recently used entries, or least used entries under the assumption that deleting these entries will do the least harm. Although a similar philosophy may be followed in the present technique, a bias is introduced that causes entries of a particular type to be replaced in preference to others. For instance, all other things being equal regarding usage and frequency, the replacement policy may prefer to delete an entry relating to data value prediction in preference to deleting one relating to memory renaming.

In some examples, when the training circuitry replaces the payload in one of the mappings with a current payload associated with the instruction, both the prediction type and the prediction are replaced. Consequently, for a given instruction, two different payloads may apply (one at a time). The payload may change when it is determined (e.g. according to the training circuitry/determination circuitry) that a different data speculation technique should be applied.

In some examples, the input comprises an instruction context; and the plurality of mappings is a plurality of mappings from the instructions and instruction contexts to the payloads such that one of the instructions may be mapped to at least two of the payloads by providing inputs with different ones of the execution instruction contexts. The instruction context could take a number of different forms and can be used to express the circumstances in which a particular instruction executes. This could take into account state of the data processing apparatus. For instance, the instruction context could be taken from a global history register and/or be based on a series of branches taken to reach the current program counter value. In this way, it is possible to differentiate between different instances of a single instruction that are likely to behave differently.

In some examples, when the predictor compares payloads, a match between the payloads requires a match between prediction type and prediction. Each entry for each instance of an instruction therefore references a single data speculation technique. In this sense, an entry may hit on the current instruction because it happens to have the same program counter value (and possibly history) of the current instruction. However, the hitting entry may not match because the payload of the hitting entry differs from the payload of the current instruction (as determined by the determination circuitry). In other words, the payload is not a part of a component used to determine a hit on an entry but is instead part of what is predicted for that entry. So if it is determined that memory renaming is applicable to the current instruction and if the current instruction hits against an entry in the prediction circuitry where the payload relates to data value prediction then there is a mismatch on the hitting entry—this can result in the confidence of that hitting entry being decremented (a match could result in the hitting entry's confidence increasing).

Particular embodiments will now be described with reference to the figures.

Memory renaming is a technique in which a load instruction loads data that is stored to memory by a nearby store instruction. In these situations, rather than merely storing the data to memory and then loading it back again (which is time consuming) it is possible to simply load the data from the register that was used for the store instruction. This allows a ‘data speculation’ to occur in that instructions can continue to execute based on this predicted data until such time as the load instruction confirms that the data is what was expected. This means that an instruction that consumes the data that was to be loaded can execute based on a register where the data is already predicted to be.

Data prediction is another technique in which the data associated with a particular instruction is predicted. This may occur when a particular instruction repeatedly loads the same data value. Over time, this can be noticed and can be stored (again in small, fast storage) so that in the future, the data can be loaded quickly from the small fast storage. Instructions can then continue to execute while the actual data is loaded from memory. If the data is what was expected then execution time is saved as compared to a situation where the system waits for the data to be loaded from memory.

Both of these techniques can be thought of as data speculation techniques in that they allow a particular data value to be predicted and for instructions to execute speculatively on the basis of those predictions. Where the prediction is correct, time is saved as compared to a situation where execution halts for the data to be acquired. Where the prediction is incorrect, the pipeline can be flushed or rewound and the situation reverts to what it would have been if execution was halted until the data was loaded.

A data processing device may be set up to enable both types of prediction to be made. In practice, however, only one data speculation technique can be used at a time—either the prediction is that a particular data value will be used, or the prediction is that the particular data value will be written by a previous (producer) instruction.

The inventors of the present technique have realised that, consequently, a single joint predictor can be provided that can produce predictions for multiple kinds of data speculation technique. In particular, by determining specifically which of several data speculation techniques should be applied to a particular instruction (rather than necessarily, how a particular prediction should be made), that data speculation technique can be recorded and used when the instruction is encountered.

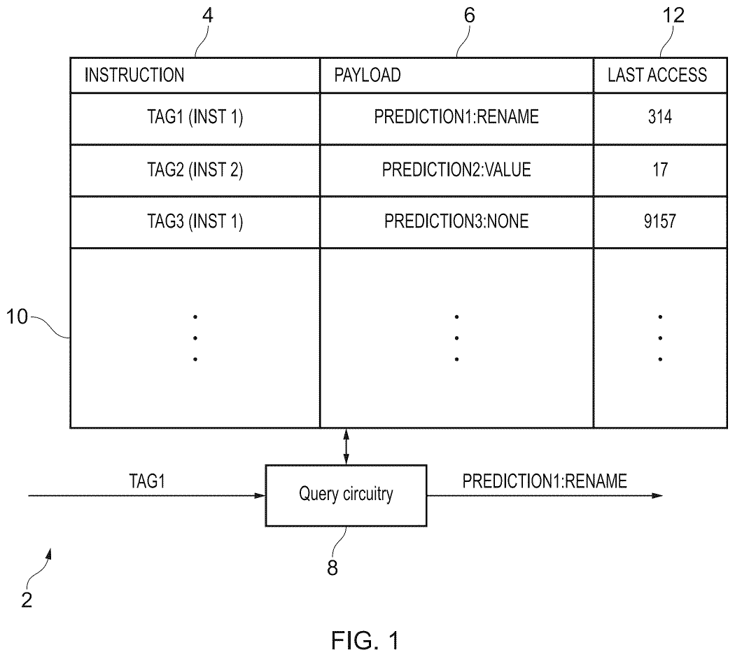

FIG. 1 schematically illustrates a data processing apparatus 2 in accordance with some examples. The apparatus includes prediction circuitry 10, which stores mappings of instructions 4 to payloads 6. In this example, the instructions are referenced according to a tag, which may be, for example, a program counter value, a hash of a program counter value (such as the least significant bits), the program counter value or program counter value hash combined with further state such as a representation of program flow (e.g. as may be produced by a global history register, which tracks the taken/not taken outcomes of recent control flow instructions), or the hash of such a combination. In this way it is possible to identify a particular instruction and it may even be possible to identify different instances of different instructions or instructions that have been arrived at in different ways (e.g. via different program flows). For instance, in FIG. 1, the same instruction (INST1) is listed twice with two different tags. Coupled with each tag is a payload. In this example, the payload is made up of two parts. One part is a prediction, the other part indicates the type of that prediction (e.g. which data speculation technique was used to produce the prediction).

In this example, only a single table is shown. However, in some examples, different tables are provided, with each table constructing the tag in a different way. For instance, each table might take a different quantity of the further state in order to generate the tag. So a first table might use none of the state, a second table might use 8 bits of the state, a third table might use 16 bits of the state and so on. In general, the table that uses the most state in generating the tag may be considered to be the most accurate on the basis that it has a bigger matching of state. One example of such a predictor is a TAGE predictor.

Each of the mappings also includes a last access 12 field. This is used to determine which entries should be removed when the storage becomes full. This will be discussed in more detail below.

For example, the payload types might be ‘Rename’ where memory renaming is the technique, or ‘Value’ where value prediction is the technique being used. In the former case, the prediction could be an indication of the store to forward from. In the latter case, the prediction could be of the data value itself. This value can be extended. For instance, rather than storing the prediction in the form of the predicted data value, the prediction could be of the location in a lookup table where the predicted data is stored. This is particularly useful where the predicted data is large and/or cannot be easily stored in the prediction circuitry 10 itself. In this situation, the prediction type or data speculation technique might be described as ‘Index’ (the index of the data value cache where the data value is stored). Another data speculation technique maybe ‘None’ or ‘Do not predict’ where no technique is to be used. This might be applicable where it has been determined it is inappropriate for any technique to be used-for instance, possibly none of the other techniques work sufficiently well. Other additional or alternative data speculation techniques are of course possible.

Query circuitry 8 is provided to receive a tag of an instruction (or other identifier), and to search the prediction circuitry 10 for the prediction associated with that instruction. The payload is then returned, containing both the prediction type and the prediction itself. This can then be passed to the appropriate circuitry (not shown) depending on the prediction type, so that the prediction can be properly made use of. For instance, in the case of memory renaming, the register renaming may be used in order to link the source and destination virtual registers together. In the case of data prediction, the data value may be acquired from a cache (if not already present) and passed to the general register file (or other data structure) ready for accessing by a later dependent instruction.

Note that in the above examples, because each of the prediction techniques relates to data value speculation, the instructions that are referenced in the prediction circuitry are memory access instructions in the form of memory load instructions. This is because memory load instructions are responsible for obtaining data, and data value speculation techniques are techniques that are applicable for allowing execution of instructions while data is acquired.

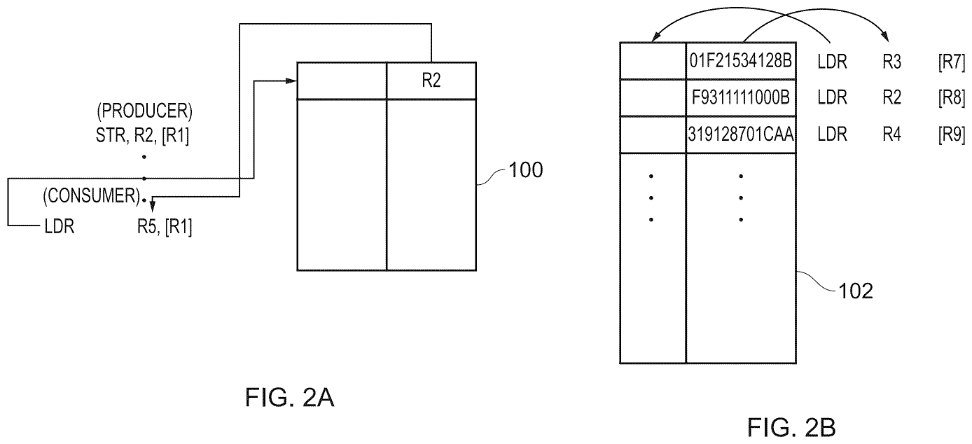

FIG. 2A gives a simple overview of memory renaming. In this example, a producer instruction seeks to store data to memory. In particular, the instruction causes data that is stored in register R2 to be written to an address of memory that is stored in register R1. Later, a consumer instruction ‘consumes’ this data by seeking to load it from memory. In particular, it loads data that is stored at a memory address stored in register R1 to a register R5. In this example, it is assumed that the data value (the memory address) stored in register R1 remains untouched between the two instructions. Consequently, the consumer instruction seeks to use the data that was written to memory by the producer instruction. If this pattern can be detected, if it can be confirmed that the value of register R1 does not change (so the same memory address was being accessed) and if the register used by the producer has not yet been overwritten, then one can use memory rename storage 100 to store a reference to the consumer instruction together with the register (R2) that should be accessed. Consequently, when the consumer instruction is encountered, the register to R5 (where the data would be loaded to from memory) can be renamed so that it consumes the data from register R2 (where the data was previously stored), e.g. via register renaming. Meanwhile, the load instruction can continue to load the data, and when it is accessed, a check can be made to ensure that the same data value was loaded (if not a rewind occurs).

FIG. 2B gives a simple overview of data value prediction. In this example, the data values acquired by load instructions (LDR) are directly predicted and stored in, e.g. a load value predictor 102. Consequently, when those load instructions are encountered in the future, the predicted data can be immediately presented from the load value predictor 102 and later instructions can continue to be executed. Meanwhile, the load instruction can continue to load the data, and when it is accessed, a check can be made to ensure that the same data value was loaded (if not a rewind occurs).

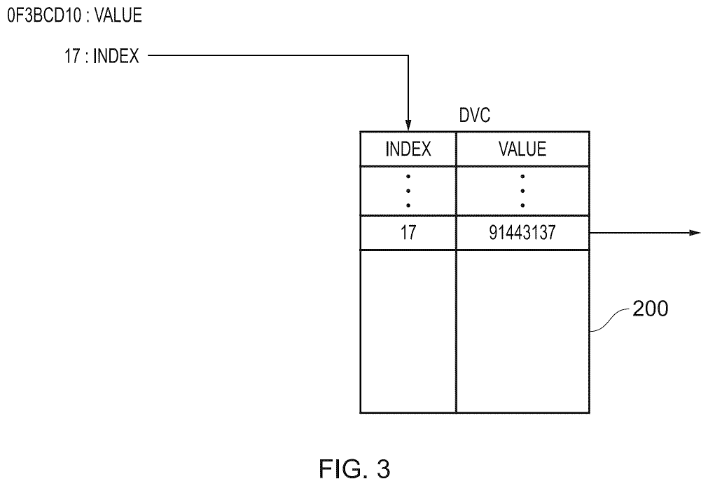

FIG. 3 shows two variant techniques that can be shown regarding the implementation of data value prediction. Both techniques can be used in parallel. In the first technique, the payload comprises the value itself (e.g. 0F3BCD10) as the prediction together with the prediction type (‘VALUE’). The value can then be directly inserted into register indicated by the load instruction. In the second technique, the payload comprises an index (e.g. 17), which is used to locate the value itself in, for instance, a data value cache (DVC) 200. This is particularly useful where the data is too large to store within the payload. In this case, a different prediction type (‘INDEX’) is used.

It will be appreciated that the above techniques are not intended to be limiting and that other techniques are equally applicable.

Having shown how the predictions can be used, we now turn to how training and allocation can be used so that the prediction circuitry 10 can be set up for querying.

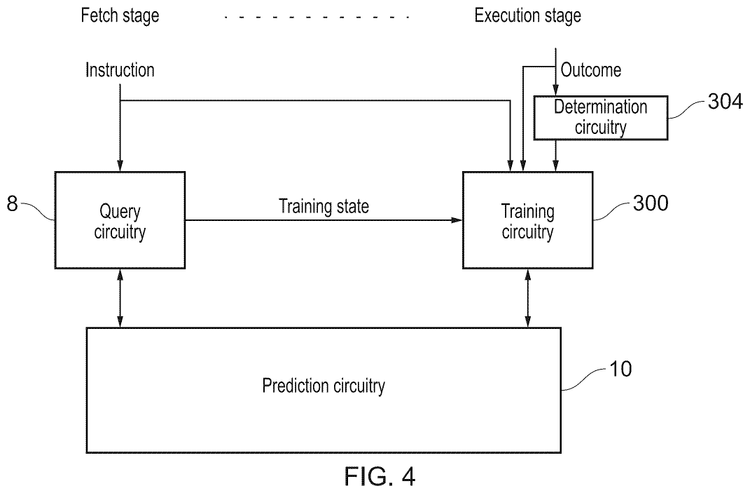

FIG. 4 shows the query circuitry 8 and the prediction circuitry 10 in the context of training. The operation of the query circuitry 8 and the prediction circuitry 10 has already been explained. This may take place during a fetch stage of a pipeline-that is the stage in which instructions are fetched from an instruction memory. At an execution stage, the actual outcome of the instruction is determined. For instance, a load instruction will be executed and whether the data value speculation occurred correctly will be known.

The determination circuitry 304 is therefore able to determine whether one of the data speculation techniques was applicable or not. As explained above, only one data speculation technique may be applicable for any given (instance of) an instruction. The determination circuitry 304 uses the available information to determine which of those techniques is most appropriate for a given instruction and training then takes place using that particular technique. The outcome of the determination circuitry, the outcome of the instruction, the details of the instruction, and the training state are then passed to training circuitry 300. The training state is provided so that it can be known, by the training circuitry 300, whether training is being performed or not in respect of the prediction without querying the prediction circuitry 10 a second time. This is important because, as will be seen below, whether or not training is being performed could impact whether any update is made to the prediction circuitry 10. If appropriate, the training data stored in the prediction circuitry 10 can then be updated. In this example, the prediction circuitry 10 is therefore being used to store training data. However, it is possible for the training data to be stored separately and for simplicity, this will be shown in later figures.

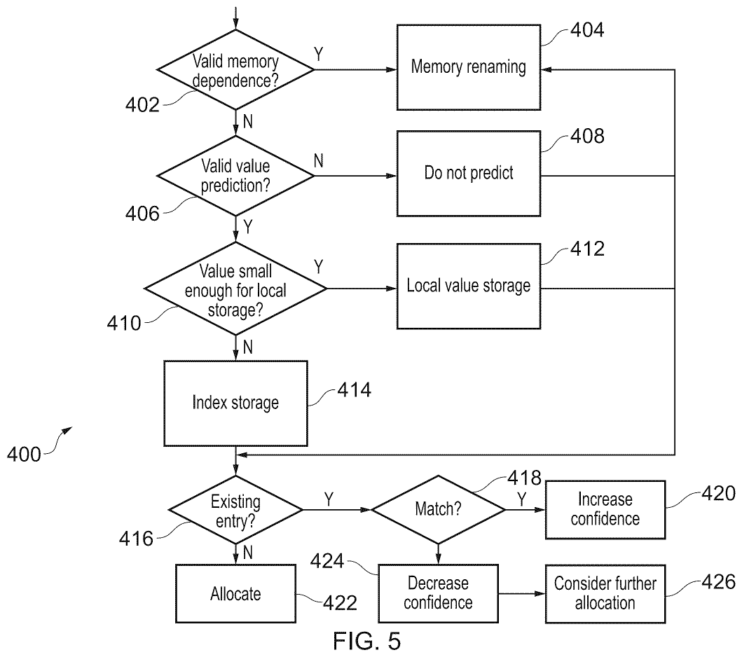

FIG. 5 illustrates an example of a process of determining which of several data value speculation techniques should be trained and/or applied to a particular instruction (instance), in the form of a flowchart 400. This process may be performed, for instance, by determination circuitry 304.

The process begins at a first step 402 where it is determined whether a valid memory dependence relationship has been detected. Here, ‘detect’ refers to the fact that the instruction appears to be eligible for memory dependence. If such a relationship is detected then memory renaming is chosen as the prediction type for the instruction, together with an indication of the data used for the memory renaming (e.g. the identity of the store instruction where the data is generated). That is to say that a memory dependence payload is used.

If the memory dependence relationship has not been detected then at step 406 it is determined whether valid value prediction has been detected. If value prediction has not been detected, then in this example there is not considered to be any valid data speculation technique that can be used and so at step 408, the instruction is marked as ‘do not predict’ so that no prediction is used. If there is a valid value prediction then at step 410 it is determined whether the predicted value is small enough that local storage (e.g. in the payload in the prediction circuitry 10 itself) can be used at step 412. Otherwise, index storage is used at step 414 and the technique that is chosen as the index in which, for instance, a data value cache where the data is stored.

In each case, after any of steps 404, 408, 412, or 414, step 416 occurs. At step 416, it is determined whether there is an existing entry in the prediction circuitry 10 that corresponds with the instruction (instance). If no such entry occurs then allocation takes place at step 422 with a default confidence (e.g. two). If there are several entries and if a history based predictor is used then the entry using the deepest level of history is considered. At step 418 it is determined whether the existing entry is a match or not. That is, whether the payload determined earlier corresponds with the payload specified for the selected entry. If so, then the confidence of that entry is increased at step 420. Otherwise, the confidence for that entry is decreased at step 424. If the confidence reaches a lower threshold (e.g. zero) then the entry's payload is replaced by the currently determined payload. In any case at step 426, further allocation is considered. In particular, if there are any tables in the prediction circuitry 10 that use more levels of history, they may be considered one at a time for allocation. This consideration may take place randomly (e.g. there may be a 50% chance of allocation occurring).

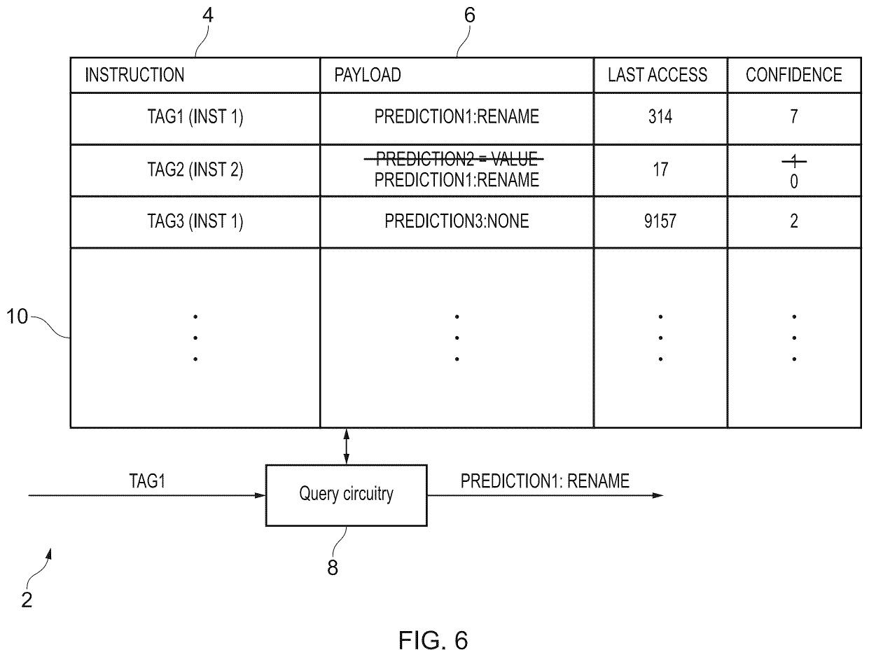

FIG. 6 illustrates an example similar to that of FIG. 1. In this example, confidence values are assigned to each entry. As in FIG. 1, it has previously been determined that data value prediction is applicable to instruction 2 (tag 2), and hence an entry exists for this instruction that refers to data value prediction. However, as training continues, it may be determined that this same instruction is applicable for memory renaming. Following the decision making process illustrated in FIG. 5, the confidence of the existing entry may be decreased each time the instruction instance is encountered, which will eventually cause the confidence to drop to 0. At this point, the payload may be updated from ‘VALUE’ (data value prediction) to ‘RENAME’ (memory renaming). In addition, the prediction itself may be updated.

Although FIGS. 5 and 6 illustrate how existing entries in the prediction circuitry 10 are updated. New allocations to the prediction circuitry 10 are not necessarily always made. The storage that is provided for the prediction circuitry 10 is limited. Some filtering of allocations might therefore take place.

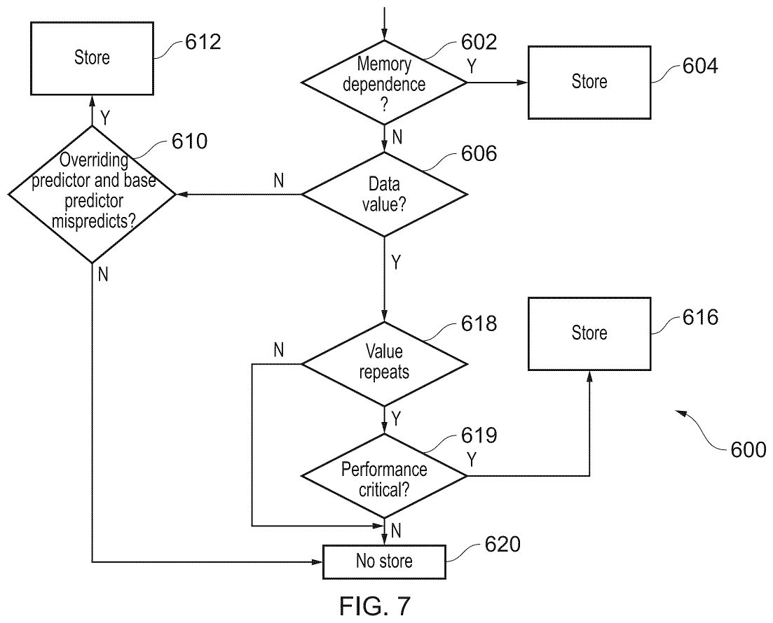

FIG. 7 illustrates a flowchart 600 that shows how allocation filtering might take place. In a step 602, it is determined whether the entry to be stored relates to memory dependence (i.e. the memory renaming technique). If so, then at step 604, the storage is made. That is to say that memory rename payloads can allocate new entries without additional filtering. The inventors have observed that these are a small fraction of all loads are less likely to overwhelm the predictor with entries, making filtering their allocation less important. Otherwise, at step 606, it is determined whether the data speculation technique relates to data value prediction. If so, then at step 618, it is determined whether the predicted data value is repetitive. That is, whether it is sufficiently certain that the predicted value will actually continue to be used. This could be achieved using a bloom filter, for instance, to determine whether it is likely that the same value has been seen before. If so, then at step 619 it is determined whether the load instruction in question is performance critical. One indicator of this is if another instruction is consuming the loaded data via a forwarding network (i.e. rather than accessing the data value from the general register file). Another indicator might be that the load instruction is holding up a commit of another instruction. Regardless, if the instruction is performance critical then the value prediction is stored. That is a store occurs if the data is both performance critical and if it repeats sufficiently often. If not (the load instruction is not performance critical or not indicative of a value that regularly repeats) then no storage occurs at step 620. If, at step 606, the storage being considered is not of a data value, then the storage (in this example) is of a ‘no prediction’ and the process proceeds to step 610. At step 610, it is determined firstly whether a base predictor is producing mispredictions and secondly whether the allocation is going into an overriding predictor. For instance, in the context of a TAGE predictor, the prediction circuitry 10 would include a base table where no history is used and only a program counter value is considered. An overriding predictor would be one in which both the program counter value and the history are considered because these override the prediction produced by the base table. If these conditions are met, then the no predict indicator is stored at a step 612 and if not then no storage occurs at step 620.

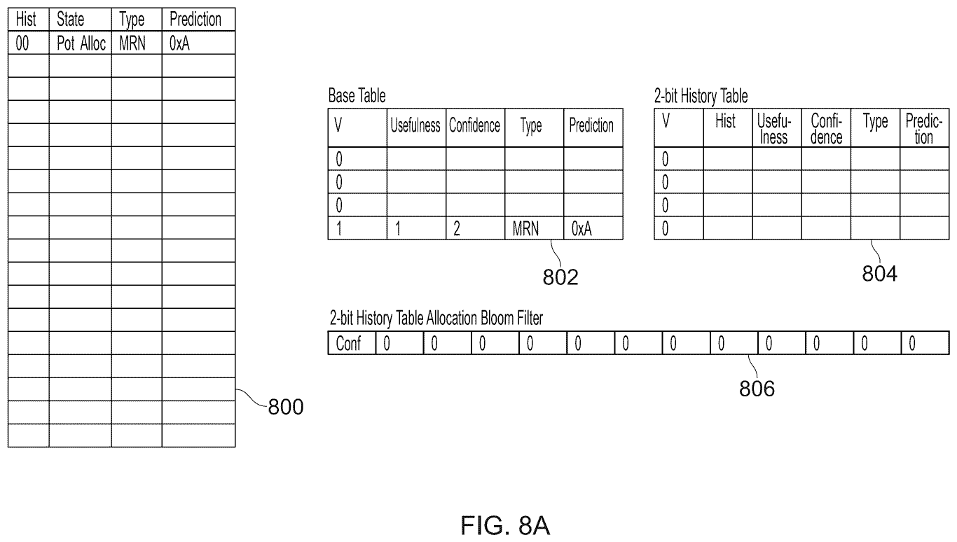

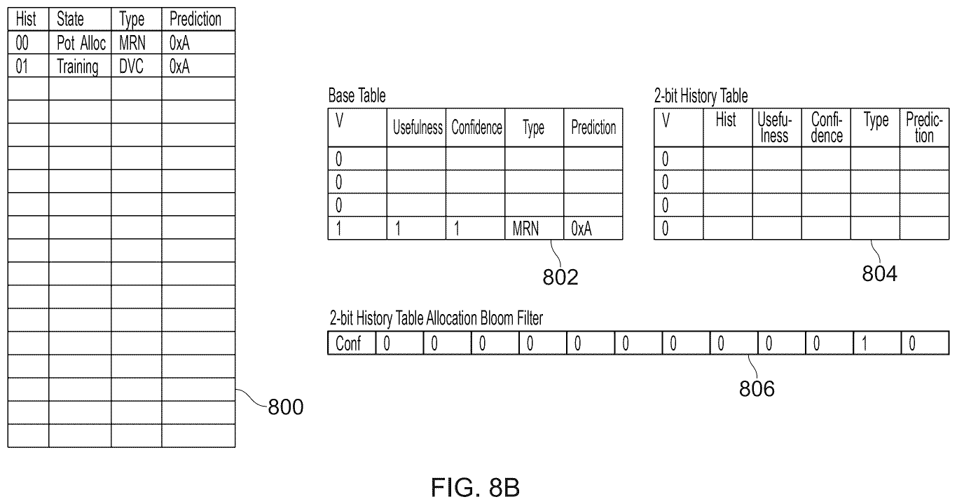

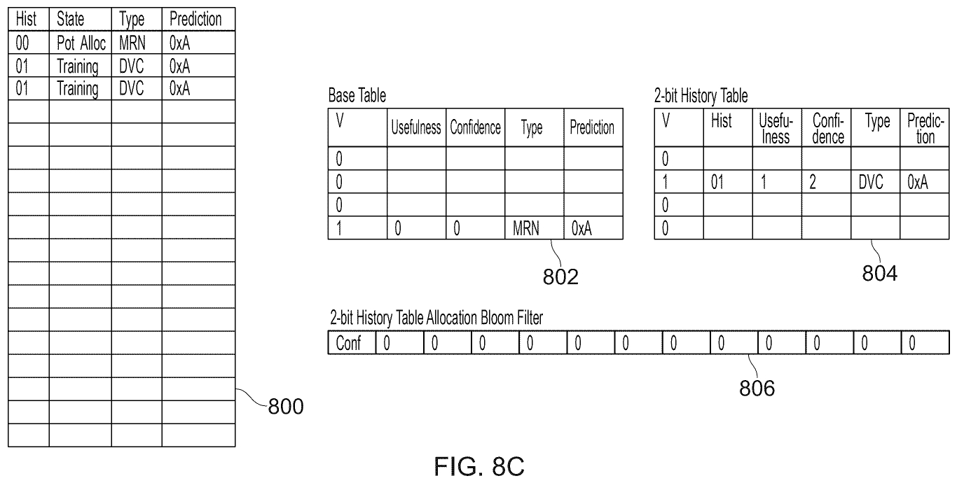

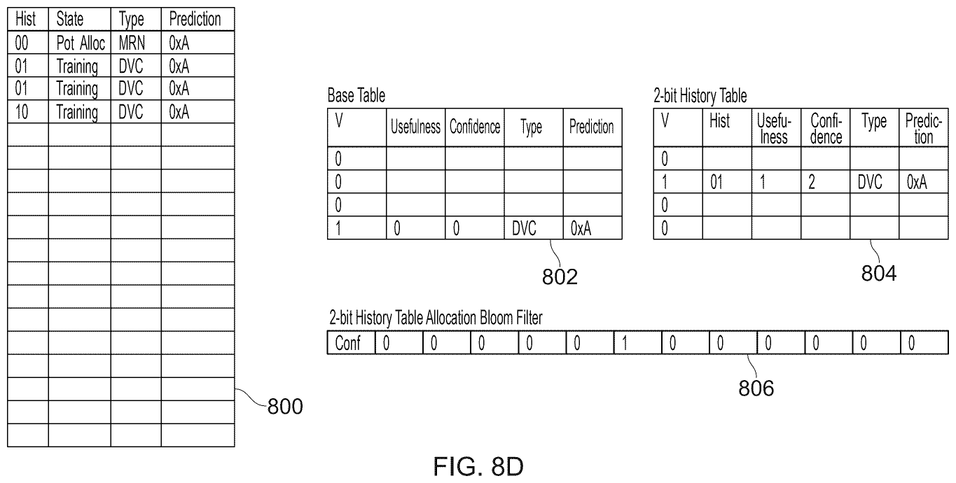

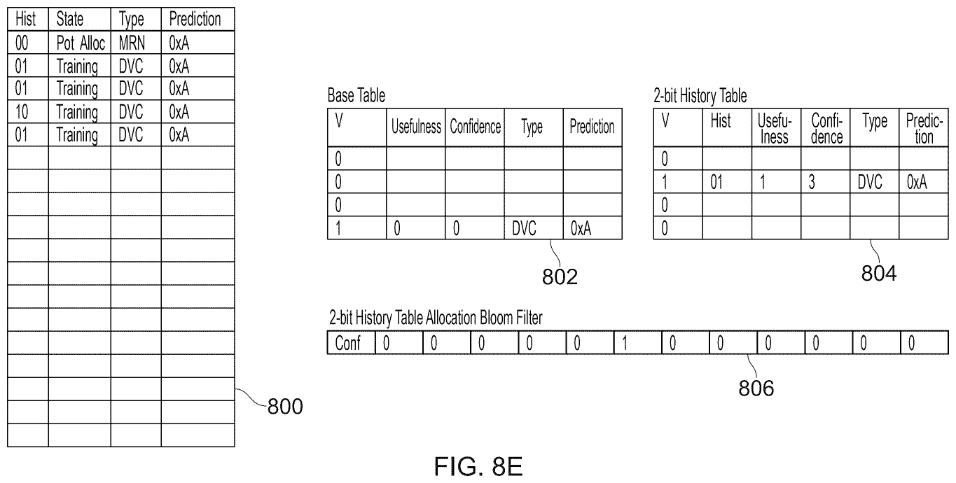

FIGS. 8A-8E show a training process. Within the figures, a series of instruction instances 800 is shown. In these examples for convenience, it is assumed that all entries relate to the same instruction (albeit with varying histories as shown in the history column). The training state column indicates the state of that instance of the instruction in respect of training. The type column indicates the data speculation type that has been noted, and the prediction column indicates the prediction that would have been made for that instruction for the specified data speculation type. Note that much of this information is provided from the initial lookup into the prediction circuitry 10 (e.g. at fetch), and is passed along to the execution/completion stage so that a further lookup is not required (as illustrated in the FIG. 4).

A base table 802 of a history based prediction circuitry 10 is also shown. Each entry has a validity flag (V), usefulness indicator (which indicates how readily an entry should be replaced), confidence score, data speculation type, and prediction. A 2-bit history table 804 of the prediction circuitry 10 is also provided. Here, entries additionally take two bits of history of the instruction into account. That is, a hit depends on both the instruction instance and the history matching an existing entry. Finally, a bloom filter 806 is provided for the 2-bit history table 804. This is used to determine whether a particular prediction has been seen before for the data value prediction technique (see step 618 in FIG. 7).

An example flow will now be illustrated, starting from FIG. 8A. At this point in time, the instruction is encountered for the first time and is not already present in any of the tables 802, 804. The training state is therefore set to ‘Potential Allocator’. It is also determined that the instruction in this context is eligible for memory renaming. This might be determined, for instance, by the fact that the data for the instruction has been obtained from the store buffer. In accordance with the method of FIG. 5, the data speculation technique is set as memory rename ‘MRN’.

When it comes to allocation, because the technique is memory rename, an entry is immediately stored (as shown in FIG. 6). In this example, we assume that when an allocation is to be made to the prediction tables 802, 804, the tables are taken in depth order until a table is selected and there exists a 50% chance of each table being written to. In this case, when the first (base) table 802 is considered, the 50% probability is met and so the allocation occurs in the base table 802. The entry that is made is marked as valid (V=1) and useful (usefulness=1). The entry also starts with a confidence of 2. The type is memory rename (MRN) and the prediction (0xA) is used to identify the instruction that provides the data.

In FIG. 8B, the instruction is encountered for a second time. This time, the history (e.g. the contents of the GHR) is 01 rather than 00. Since the instruction has been encountered (because there is an entry for the instruction in one of the tables 802, 804), the training state is ‘Training’. On this occasion, there is no suggestion that memory renaming is usable but instead, data value prediction is considered to be valid (DVC). Once again, the prediction is 0xA although this is by coincidence. The meaning of the prediction is different because in this situation the prediction might be the predicted data whereas with memory rename it may refer to a previous instruction.

Since there is a match in the base table 802 for the instruction, a comparison is made between the payload of the entry in the deepest hitting table 802 and the payload of the current instruction instance. Here there is a mismatch because although the predictions match, the prediction types (data speculation techniques) do not match. In the base table entry the type is MRN and for the current instruction instance the type is DVC. Consequently, the hitting entry has its confidence decremented (from 2 to 1).

It is considered whether an allocation should be made to a further table 804 other than the base table 802. Here, the 50% probability passes, meaning that an allocation is considered. However, this time the allocation is for a data value prediction and so is not automatic. Here it is assumed that the instruction is critical, but there is no evidence from the bloom filter that the prediction is repeatable. Consequently, no allocation is made (in accordance with the allocation filtering of FIG. 6). However, the bloom filter is updated to indicate that this prediction has been previously encountered. This is achieved by performing a hash on the combination of the program counter value, prediction, and history to form an index, which is used to update the bloom filter (hence, index 11 of the bloom filter is set to 1).

In FIG. 8C, the instruction is encountered for the third time. This instance of the instruction is the same as the instance encountered in FIG. 8B. In other words, the history (01) is the same. As before, the deepest table for which a hit occurs is the base table 802, which mismatches. Consequently, the confidence of the hitting entry is reduced to 0. This in turn changes the usefulness to 0 meaning that the entry will be replaced in the future. Again, an attempt is made to update the 2-bit history table 804. Once again, the 50% probability is met. This time, the repeatability test passes because there is an entry in the bloom filter 806 for the hash of the combination of program counter value, prediction, and history. The bloom filter index is therefore reset to 0 and an entry is made into the 2-bit history table 804.

The entry that is made into the 2-bit history table 804 is an entry that is valid (V=1), contains the history of this instance of the instruction (01), is initially marked as useful (usefulness=1) and with a confidence of 2. Furthermore, the type and the prediction are both set to match the payload of the current instruction (DVC and 0xA).

In FIG. 8D, a new instance of the instruction is encountered, this time with a history of 01. The prediction type is determined as a DVC (as with some other previous instruction instances). This new instance hits in the base table 802, which causes the type stored in the table 802 to change from MRN to DVC (because the usefulness of the hitting entry is 0). Despite this change, the confidence does not increase and because the confidence remains at 0, the usefulness also remains at 0. The 50% chance succeeds again for the 2-bit history table 804 and because the type is data value prediction, the bloom filter 206 is updated to test for repeatability.

In FIG. 8E, the instruction instance is observed with a history of 01. The determined type is DVC. The deepest table at which a hit occurs is the 2-bit history table 804. Here there is a match against the entry and so the confidence value is incremented (from 2 to 3). If further history tables existed then a further allocation might be attempted. However, such tables are not present in this example.

In due course, the confidence value of an entry may saturate, at which point the incoming instruction may become ‘Predict’, indicating that training is no longer taking place. This does not necessitate, however, that the confidence value is immutable. Indeed, the confidence value may decrease in the case of future mismatches.

At some point, it may become necessary for replacements to be made in the predictor 10. This is because the storage used for the predictor 10 is limited. In order to determine an entry that should be deleted, one can consider the ‘last access’ 12 field. This field 12 indicates how long ago a particular entry was used (e.g. how recently a particular instruction was encountered). In general, less recently accessed entries should be deleted in preference to more recently accessed entries.

However, value prediction payloads are more common and less performance critical than memory dependence payloads. Thus, memory dependence payloads should be slightly less favoured for removal. There are a number of ways of doing this. For instance, a threshold could be introduced that the last access 12 value must reach before a memory dependence entry can be deleted. This threshold might need to be higher than for data value prediction entries. Another mechanism that can be used is to measure ‘usefulness’. Each time an entry is used, the usefulness increases. Meanwhile, the usefulness value of entries may decrease whenever a failed allocation counter overflows. Entries relating to memory dependence could be increased more (when used) and/or decreased less (when the counter overflows).

Note that although the above explanation uses a single table for training and for prediction, it is possible for entries that are undergoing training to be kept in a separate ‘training table’.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

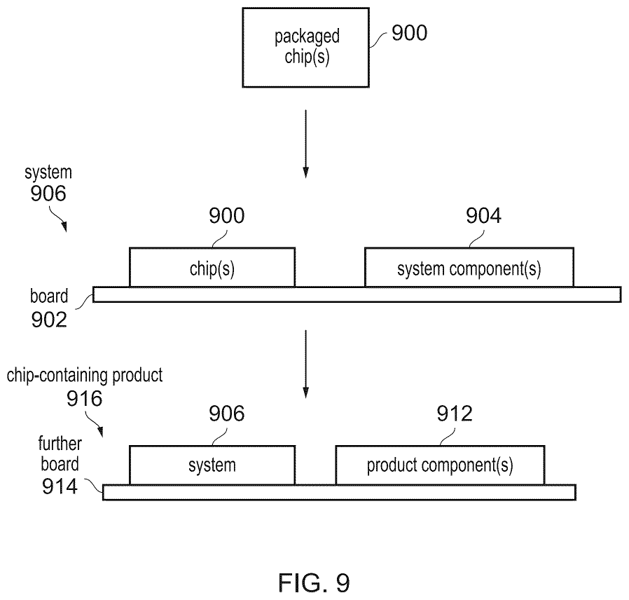

As shown in FIG. 9, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 900 are assembled on a board 902 together with at least one system component 904 to provide a system 906. For example, the board may comprise a printed circuit board. The board substrate may be made of any of a variety of materials, e.g. plastic, glass, ceramic, or a flexible substrate material such as paper, plastic or textile material. The at least one system component 904 comprise one or more external components which are not part of the one or more packaged chip(s) 900. For example, the at least one system component 904 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 916 is manufactured comprising the system 906 (including the board 902, the one or more chips 900 and the at least one system component 904) and one or more product components 912. The product components 912 comprise one or more further components which are not part of the system 906. As a non-exhaustive list of examples, the one or more product components 912 could include a user input/output device such as a keypad, touch screen, microphone, loudspeaker, display screen, haptic device, etc. ; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 906 and one or more product components 912 may be assembled on to a further board 914.

The board 902 or the further board 914 may be provided on or within a device housing or other structural support (e.g. a frame or blade) to provide a product which can be handled by a user and/or is intended for operational use by a person or company.

The system 906 or the chip-containing product 916 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

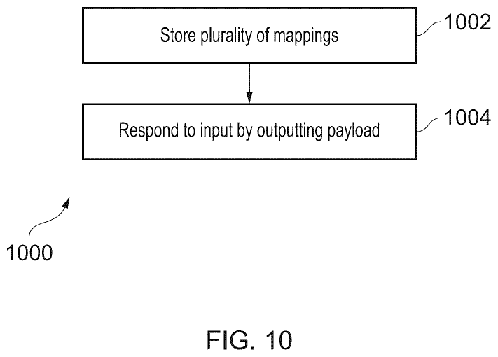

FIG. 10 illustrates a flowchart 1000 that shows a method of data processing in accordance with some examples. At a step 1002, a plurality of mappings from instructions to payloads is stored. The payloads comprise one of a plurality of predictions and a prediction type configured to indicate which of a plurality of data speculation prediction techniques the one of a plurality of predictions prediction type relates. The prediction type is stored as one of several possible different prediction types. At a step 1004, an input is received which contains a reference to one of the instructions. The resulting response includes one of the payloads that has been stored that maps to the instruction that is referenced in the input.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and System Verilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

Embodiments can be configured as follows:
1. A data processing apparatus comprising:
   prediction circuitry configured to store a plurality of mappings from instructions to payloads; and
   query circuitry configured to respond to a reference to one of the instructions provided as at least part of an input by outputting one of the payloads that maps to the one of the instructions, wherein
   the payloads comprise one of a plurality of predictions and a prediction type configured to indicate which of a plurality of data speculation techniques the one of a plurality of predictions relates; and
   the prediction circuitry is configured, for each of the instructions, to store the prediction type as one of a plurality of different prediction types.
2. The data processing apparatus according to any preceding clause, wherein
   each of the instructions is a memory access instruction.
3. The data processing apparatus according to any preceding clause, wherein
   the data speculation techniques include a memory rename operation and a data value prediction operation.
4. The data processing apparatus according to clause 3, wherein
   in the memory rename operation, the one of the instructions is predicted as a load instruction that loads data from a memory address and the data is predicted to be produced by a corresponding producer instruction, which is a store instruction configured to store the data to the memory address prior to the instruction being executed.
5. The data processing apparatus according to any one of clauses 3-4, wherein
   the plurality of predictions includes: an indication of data that is predicted to be used by a value predictable instruction, and an indication of a previous producer instruction whose data is to be used by a memory renamable instruction.
6. The data processing apparatus according to clause 4, wherein
   the indication of the data is any one of: an indication of an index of data storage circuitry where the data can be found, and the data.
7. The data processing apparatus according to any one of clauses 2-6, comprising:
   determination circuitry configured to perform a determination of which of the data speculation techniques an instruction should be subject to; and
   training circuitry configured to update or allocate an entry in the prediction circuitry in respect of the instruction, based on the determination.
8. The data processing apparatus according to any one of clauses 3-6, comprising:
   determination circuitry configured to perform a determination of whether an instruction should be subject to the memory rename operation and whether the instruction should be subject to the data value prediction operation; and
   training circuitry configured to update or allocate an entry in the prediction circuitry in respect of the instruction, based on the determination.
9. The data processing apparatus according to any one of clauses 7-8, wherein
   the training circuitry is configured to allocate an entry to the prediction circuitry based on an allocation condition, which differs for the plurality of data speculation techniques.
10. The data processing apparatus according to any one of clauses 7-9, wherein
   the determination circuitry is configured to determine which of the data speculation techniques an instruction should be subject to based on a hierarchy; and
   at least one of the data speculation techniques is determined based on a further condition being met.
11. The data processing apparatus according to any one of clauses 7-10, wherein
   the training circuitry is configured to filter accesses to the prediction circuitry made in respect of a given instruction based on an indication of whether the given instruction is being trained or is trained.
12. The data processing apparatus according to any one of clauses 7-11, wherein
   the training circuitry is configured to perform training in respect of the instruction using a predicted value comprising a determined payload comprising a determined prediction type and a determined prediction.
13. The data processing apparatus according to any preceding clause, wherein
   the prediction circuitry is configured to implement a replacement policy, which biases replacing mappings based on the prediction type.
14. The data processing apparatus according to any one of clauses 8-14, wherein
   when the training circuitry replaces the payload in one of the mappings with a current payload associated with the instruction, both the prediction type and prediction are replaced.
15. The data processing apparatus according to any preceding clause, wherein
   the input comprises an instruction context; and
   the plurality of mappings is a plurality of mappings from the instructions and instruction contexts to the payloads such that one of the instructions may be mapped to at least two of the payloads by providing inputs with different ones of the instruction contexts.
16. The data processing apparatus according to any preceding clause, wherein
   when the predictor compares payloads, a match between the payloads requires a match between prediction type and prediction.
17. A system comprising:
   the data processing apparatus according to any preceding clause, implemented in at least one packaged chip;
   at least one system component; and
   a board, wherein
   the at least one packaged chip and the at least one system component are assembled on the board.
18. A chip-containing product comprising the system of clause 17, wherein
   the system is assembled on a further board with at least one other product component.
19. A data processing method comprising:
   storing a plurality of mappings from instructions to payloads;
   responding to a reference to one of the instructions provided as at least part of an input by outputting one of the payloads that maps to the one of the instructions, wherein
   the payloads comprise one of a plurality of predictions and a prediction type configured to indicate which of a plurality of data speculation prediction techniques the one of a plurality of predictions prediction type relates; and
   for each of the instructions, the prediction type is stored as one of a plurality of different prediction types.
20. A non-transitory computer-readable medium storing computer-readable code for fabrication of the data processing apparatus of any one of clauses 1-16.

1. A data processing apparatus comprising:
prediction circuitry configured to store a plurality of mappings from instructions to payloads; and
query circuitry configured to respond to a reference to one of the instructions provided as at least part of an input by outputting one of the payloads that maps to the one of the instructions, wherein
the payloads comprise one of a plurality of predictions and a prediction type configured to indicate which of a plurality of data speculation techniques the one of a plurality of predictions relates; and
the prediction circuitry is configured, for each of the instructions, to store the prediction type as one of a plurality of different prediction types.

2. The data processing apparatus according to claim 1, wherein each of the instructions is a memory access instruction.

3. The data processing apparatus according to claim 1, wherein the data speculation techniques include a memory rename operation and a data value prediction operation.

4. The data processing apparatus according to claim 3, wherein
in the memory rename operation, the one of the instructions is predicted as a load instruction that loads data from a memory address and the data is predicted to be produced by a corresponding producer instruction, which is a store instruction configured to store the data to the memory address prior to the instruction being executed.

5. The data processing apparatus according to claim 3, wherein
the plurality of predictions includes: an indication of data that is predicted to be used by a value predictable instruction, and an indication of a previous producer instruction whose data is to be used by a memory renamable instruction.

6. The data processing apparatus according to claim 4, wherein the indication of the data is any one of: an indication of an index of data storage circuitry where the data can be found, and the data.

7. The data processing apparatus according to claim 2, comprising:
determination circuitry configured to perform a determination of which of the data speculation techniques an instruction should be subject to; and
training circuitry configured to update or allocate an entry in the prediction circuitry in respect of the instruction, based on the determination.

8. The data processing apparatus according to claim 3, comprising:
determination circuitry configured to perform a determination of whether an instruction should be subject to the memory rename operation and whether the instruction should be subject to the data value prediction operation; and
training circuitry configured to update or allocate an entry in the prediction circuitry in respect of the instruction, based on the determination.

9. The data processing apparatus according to claim 7, wherein
the training circuitry is configured to allocate an entry to the prediction circuitry based on an allocation condition, which differs for the plurality of data speculation techniques.

10. The data processing apparatus according to claim 7, wherein
the determination circuitry is configured to determine which of the data speculation techniques an instruction should be subject to based on a hierarchy; and
at least one of the data speculation techniques is determined based on a further condition being met.

11. The data processing apparatus according to claim 7, wherein
the training circuitry is configured to filter accesses to the prediction circuitry made in respect of a given instruction based on an indication of whether the given instruction is being trained or is trained.

12. The data processing apparatus according to claim 7, wherein
the training circuitry is configured to perform training in respect of the instruction using a predicted value comprising a determined payload comprising a determined prediction type and a determined prediction.

13. The data processing apparatus according to claim 1, wherein
the prediction circuitry is configured to implement a replacement policy, which biases replacing mappings based on the prediction type.

14. The data processing apparatus according to claim 8, wherein
when the training circuitry replaces the payload in one of the mappings with a current payload associated with the instruction, both the prediction type and prediction are replaced.

15. The data processing apparatus according to claim 1, wherein
the input comprises an instruction context; and
the plurality of mappings is a plurality of mappings from the instructions and instruction contexts to the payloads such that one of the instructions may be mapped to at least two of the payloads by providing inputs with different ones of the instruction contexts.

16. The data processing apparatus according to claim 1, wherein
when the predictor compares payloads, a match between the payloads requires a match between prediction type and prediction.

17. A system comprising:
the data processing apparatus according to claim 1, implemented in at least one packaged chip;
at least one system component; and
a board, wherein
the at least one packaged chip and the at least one system component are assembled on the board.

18. A chip-containing product comprising the system of claim 17, wherein
the system is assembled on a further board with at least one other product component.

19. A data processing method comprising:
storing a plurality of mappings from instructions to payloads;
responding to a reference to one of the instructions provided as at least part of an input by outputting one of the payloads that maps to the one of the instructions, wherein
the payloads comprise one of a plurality of predictions and a prediction type configured to indicate which of a plurality of data speculation prediction techniques the one of a plurality of predictions prediction type relates; and
for each of the instructions, the prediction type is stored as one of a plurality of different prediction types.

20. (canceled)
